(19) United States
(12) Patent Application Publication
(10) Pub. No.: US 2003/0054857 A1
(43) Pub. Date: Mar. 20, 2003

(54) Cellular phone timer

(76) Inventor: Howard Fong, Temple City, CA (US)

Correspondence Address: James E. Brunton, Esquire, P. O. Box 29000, Glendale, CA, 91209-9000, US

(21) Appl. No.: 09/953,135

(22) Filed: Sep. 14, 2001

(51) Int. Cl. H04M 1/00

(52) U.S. Cl. 455/557; 455/556

(57) ABSTRACT

A compact, self-contained timer assembly for use in connection with a cellular telephone assembly for selectively metering and displaying accumulated time of telephone conversations. The apparatus includes an adhesive film assembly that is affixed to the back of the timer and can be used to securely affix the timing device to the back of a cellular telephone or to the back of a carrying case within which the cellular telephone is carried. The timer assembly also uniquely includes audio signaling means for emitting an audio signal upon the passage of a particular interval of time.

### BACKGROUND OF THE INVENTION

1. Field of the Invention

The present invention relates generally to timing devices. More particularly, the invention concerns a self-contained, compact timing device that can be readily affixed to a cellular phone assembly to allow user to selectively meter and digitally display accumulated time during all telephone conversations within a time cycle after a zero reset as, for example, one month.

2. Discussion of the Prior Art

In recent years the use of cellular phones has become extremely popular. As a general rule, charges for usage of the cellular phone accumulates only during peak usage time periods of the day and not during off peal, time periods such as evenings and weekends. Some cell phone companies also have calling plans that charge outgoing calls only and no charge for incoming calls. The cell phone companies usually provide a monthly lump sum fixed amount of minutes during these peak billing periods for a lump sum monthly pricing plan. As long as the cell phone user stays within the lump sum minutes of the particular paid calling plan, no further charges are accrued. But any additional minutes used beyond these lump sum minutes, and the charges starts accruing at a much high rate.

It is important therefore for the cell phone user to keep track of the accumulated passage of time in the normal billing cycle, typically one month, for only those calls that are being billed during the peak billing periods based on their specific calling plan. It is important for the user to be able to manually activate a timer to count the running total of all the calls that are made only during those time periods. For those other off-peak time periods such as evenings or weekends, or for incoming calls that are free for some plans, the user would not activate and time these calls. Without a running total of the time used only during peak periods which are billed, the user has no way of knowing how many minutes are left unused in the plan and ends up wasting minutes that are otherwise already prepaid by the monthly program.

Because the cellular phone is used at a number of different locations during the conduct of various types of activities such as driving, walking and dining, it is often difficult to keep track of elapsed time during the telephone conversation, and ultimately, the running total of time used up to the moment in the current monthly billing cycle.

For these reasons, there is a need for a self-contained timer that can be conveniently affixed to the cellular phone and is readily available to the user during the progress of the conversation so that the user can activate the timer's clock only during those time periods when the user is being charged, to accurately keep track of, and be informed of, the accumulated time. With this knowledge, the user is aware of how much time is still available to use without exceeding the allotted prepaid quota of time.

A number of different types of portable, self-powered devices for storing and retrieving data are well known. One such device is disclosed in U.S. Pat. No. 5,689,476 issued to Leach. The Leach device comprises a hand-held, battery-powered portable monitor for reporting elapsed time and for calculating cost charges based on elapsed time. The monitor selectively displays constantly updated elapsed time and constantly updated charges, which accrue with the elapsed time. A clock generates a data signal relating to elapsed time and a memory device is provided with data relating to charges accruing with respect to the elapsed time. U.S. Pat. No. 5,222,127 issued to Fukui concerns a portable telephone of the type to which a plurality of subscriber numbers are registered and includes a timer for measuring a calling period of time from the start of calling to the end of calling and a memory device for saving and integrating data for each subscriber number. The Wong U.S. Pat. No. 4,920,556 concerns an improved telephone with three built-in features that provide added convenience and additional benefits to the user. These features are: a money saver timer which tells the caller the amount of time left of a current message or toll unit on a long distance call; a telephone panic switch which, when pressed, will activate a circuit that will automatically call and broadcast an emergency message; and music-on-hold cards which allows the user to play different music programs for the hold feature. U.S. Pat. No. 4,473,718 issued to Ettel concerns a timing device for use with a telephone having a held-held receiver/transmitter replaceable on the phone when not in use. The timing device includes a battery-operated, self-zeroing, liquid-crystal display clock module provided with a normally closed switch. A feeler arm for activation of the clock module is provided which controls the position of the switch and biasing is provided urging the switch and the feeler arm to close the switch and operate the clock module when no external forces are provided on the feeler arm. U.S. Pat. No. 4,145,873 issued to Nicodemo concerns a timing device for accumulating a telephone long distance call charge. Basically, the Nicodemo device is simply a modified stopwatch and must be used in conjunction with a push-button calculator incorporating an automatic constant function.

While the devices disclosed in the aforementioned patents are useful in determining elapsed time for various purposes, none have the convenience and capabilities of the apparatus of the present invention and none can be readily used with portable telephones, such as cellular telephones, to meter, signal and display, in digital form, the running total of time used up to the moment in the current billing cycle.

### SUMMARY OF THE INVENTION

By way of summary, the present invention concerns a timer assembly that can be quickly and easily connected to a cellular phone without modifying the cellular phone and without the need for special tools. The timer assembly includes a housing, a manually operated switch carried by the housing, novel connector means connected to the housing for readily connecting the timer assembly to the cellular phone assembly, and timing means contained within the housing and operably associated with the manually operated switch for metering and displaying in digital form the accumulated time from the operation of the manually operated switch. The timer assembly also uniquely includes audio signaling means for emitting an audio signal upon the passage of a particular interval of time.

With the foregoing in mind, it is an object of the invention to provide a compact, portable, self-contained device that can be easily affixed to a cellular telephone to measure accumulated time and simultaneously display in digital form the accumulated time.

Another objective of the invention is to provide a device of the character described that uniquely includes audio signaling means for emitting an audio signal upon passage of a particular interval of time. The audio signal serves as a reminder to the user that a particular interval of time, typically a full minute, is almost up and if the user chooses to end the conversation within the next few seconds, then the user would not have to incur any additional time charges. However, should the user decide to continue the conversation, the user has the knowledge that a full interval of time, typically a minute, is available to complete the conversation without the need then to rush and end the call at that moment.

Another object of the invention is to provide a device of the aforementioned character, which includes means for easily clearing the elapsed time display so that a new time period may be measured and displayed.

Another object of the invention is to provide a device as described in the preceding paragraphs in which the timing device is self-contained and remains independent of external connections.

Another object of the invention is to provide a timing device as described in the preceding paragraphs that is inexpensive to manufacture, is convenient in use, and can be easily and quickly interconnected with a cellular telephone or with exterior of a carrying case within which the cellular telephone is carried.

The foregoing objects of the invention as well as other unique features of the invention will become apparent from the discussion that follows.

### BRIEF DESCRIPTION OF THE DRAWINGS

FIG. 1 is a generally perspective view of one form of the cellular phone timer of the invention.

FIG. 2 is a generally perspective, exploded view showing the attachment means for removably affixing the timer to a cellular telephone.

FIG. 3 is a generally perspective, diagrammatic view illustrating the use of the cellular phone timer in conjunction with a cellular phone.

FIG. 4 is a generally perspective view showing the cellular phone timer removably affixed to a cellular phone carrying case.

FIG. 5 is a generally perspective, diagrammatic view showing the use of the device illustrated in FIG. 4.

FIG. 6 is a generally schematic view showing the various components that makeup the timer of the invention.

### DESCRIPTION OF THE INVENTION

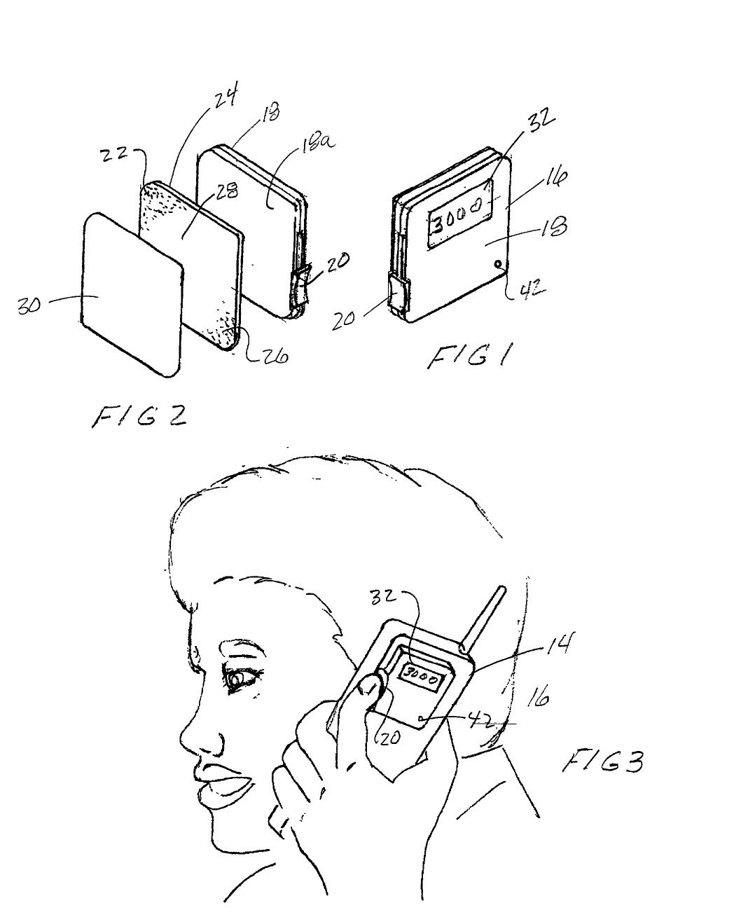

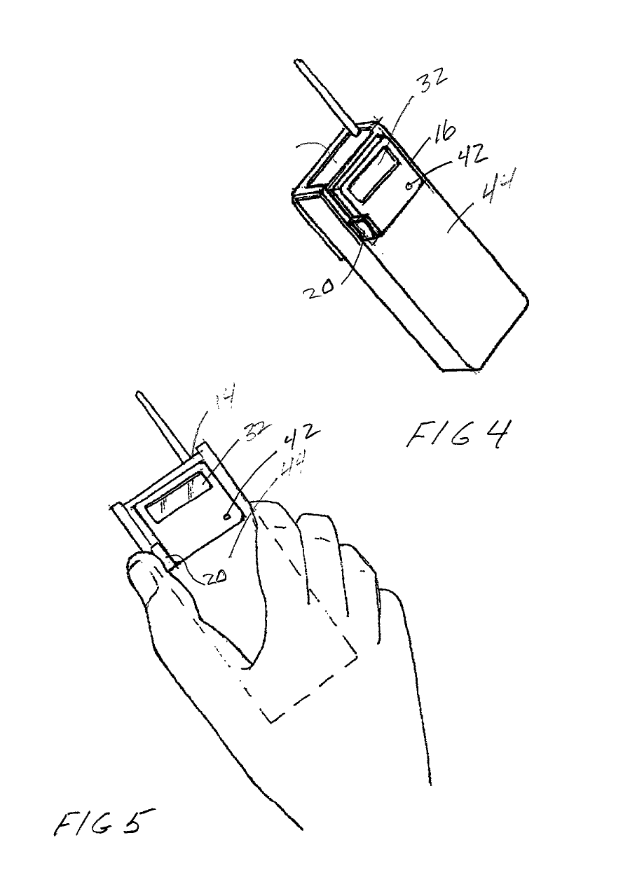

Referring to the drawings and particularly to FIGS. 1 through 3, one form of the apparatus of the present invention is there illustrated. As shown in FIG. 3, the apparatus here comprises in combination a cellular phone assembly 14 and a self-contained timer assembly 16 that is interconnected with the cellular telephone assembly 14 in the manner shown in FIG. 3.

In the present form of the invention, the timer assembly comprises a hollow or solid flexible housing 18, a manually operated switch 20 that is carried at the side of the housing and connector means connected to the housing for connecting the timer assembly to the cellular telephone assembly. In the present form of the invention, this connector means comprises a thin connector film 22 having an adhesive 24 provided on the rear surface thereof to enable the thin film 22 to be adhesively connected to the rear surface 1 8a of housing 18. Additionally, thin film 22 is provided with a second adhesive layer 26 on the front surface thereof that is generally designated in the drawings by the numeral 28. Until time of use, a peel away film 30 covers the adhesive coating 26. Upon removal of the peel away film 30, the timer can be affixed to the telephone assembly in the manner shown in FIG. 3 by simply pressing the adhesive layer 26 against a flat surface on the back of the cellular telephone. As indicated in FIG. 3, the timing device 16 is preferably strategically positioned on the cellular phone so that the switch 20 is easily accessible by a finger or thumb of the user so that the timer can easily be started by the user at the time the telephone conversation commences.

Referring particularly to FIGS. 1, 3, and 6, in the present form of the invention, the timer device 16 is provided with a readily visible liquid crystal display 32 that displays in digital form the accumulated running total of time from operation of switch 20. Mounted within housing 16 is a central processor 34, which is of conventional construction and can take the form of a timing chip of a character well known by those skilled in the art. The timing chip or central processor 34, that is readily commercially available from sources such as the Timerica Company of Harbor City, Calif. functions to measure the accumulated time in minutes from a zero time that exists at the time of operation of the manually operated on/off switch 20. Disposed between the on/off switch 20 and central processor 34 is a conventional battery 36 that powers the unit. Interconnected with central processor 34 is the previously mentioned audio signaling means that is shown here as a beep reminder 40 that emits an audio signal for each minute that has elapsed as measured by the central processor 34. With this unique feature, the cellular telephone user can be reminded of the ensuing full minute without having to constantly refer to the liquid crystal display 32. However, at any time that the user desires, the liquid crystal display 32 can be consulted to more accurately determine the total amount of time that has accumulated during the telephone billing cycle.

Also interconnected with the central processor 34 is a zero reset switch 42 that, as shown in FIG. 1, is deliberately recessed on the outside of the housing 18 to prevent accidental operation. At the beginning of each monthly or other billing cycle, the zero reset switch 42 can be touched with a pointed objected such as a pen or pencil to automatically reset the display 32 to zero.

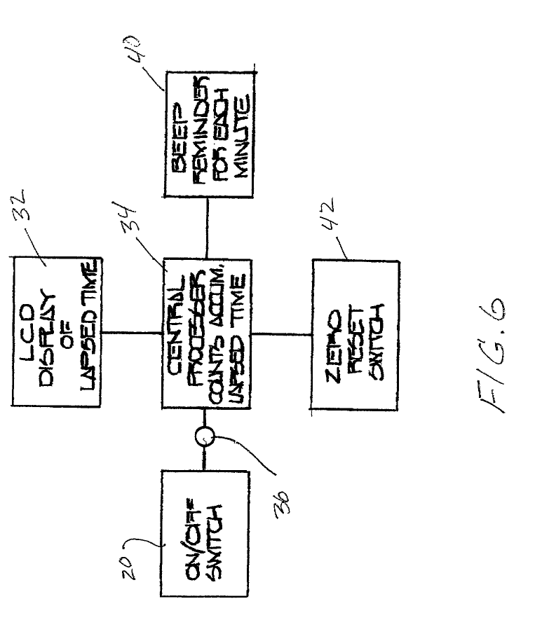

Each of the components of the timing device, as shown in FIG. 6, are readily commercially available and their manner of interconnection is well understood by those skilled in the art. While various commercial sources can provide the components of the timing device shown in FIG. 6, such components are readily available from the previously identified Timerica Company of Harbor City, Calif. Turning next to FIG. 4 and 5, an alternate manner of usage of the timing device of the invention is there illustrated. In this form of the invention, the timing device 16, which is identical to that previously described, is affixed to a carrying case 44 within which the cellular telephone 14 is carried. In using the timing device in connection with the carrying case 44, once again the peel covering 30 is first peeled from the adhesive coating 28. This done, the adhesive covered surface 28 is pressed against the back surface of the carrying case 44 so as to securely affix the timer unit to the cellular telephone assembly in a manner such that the switch 20 is conveniently available to the user in the manner shown in FIG. 5.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A hand-held communication apparatus comprising:
(a) a cellular phone assembly; and
(b) a timer assembly connected to said cellular phone assembly, said timer assembly comprising:
(i) a housing;
(ii) a manually operated switch carried by said housing;
(iii) connector means connected to said housing for connecting said timer assembly to said cellular phone assembly; and
(iv) timing means contained within said housing and operably associated with said manually operated switch for measuring and displaying accumulated time following at least one operation of said manually operated switch.

2. The apparatus as defined in claim 1 in which said connector means comprises a thin connector film affixed to the cell phone assembly, said thin connector film having a layer of adhesive disposed thereon for gripping said housing of said timer assembly.

3. The apparatus as defined in claim 1 in which said timing means comprises:
(a) a central processor mounted within said housing for measuring the accumulated time in minutes from a time zero following a plurality of operations of said manually operated switch; and
(b) a liquid crystal display mounted within said housing for displaying the accumulated time measured by said central processor.

4. The apparatus as defined in claim 3 in which said timing means further comprises audio signal means carried by said housing and connected to said central processor for emitting an audio signal upon the passing of each minute of elapsed time.

5. The apparatus as defined in claim 4 in which said timing means further comprises reset means carried by said housing and operably associated with said central processor for resetting said central processor to a time zero.

6. A hand-held communication apparatus comprising:
(a) a cellular phone assembly; and
(b) a timer assembly connected to said cellular phone assembly, said timer assembly comprising:
(i) a housing;
(ii) a manually operated switch carried by said housing;
(iii) connector means connected to said housing for connecting said timer assembly to said cellular phone assembly; and
(iv) timing means contained within said housing and operably associated with said manually operated switch for measuring and displaying accumulated time from at least one operation of said manually operated switch, said timing means comprising:
a. a central processor mounted within said housing for measuring the accumulated time in minutes from a time zero following a plurality of operations of said manually operated switch; and
b. a liquid crystal display mounted within said housing for displaying the accumulated time measured by said central processor; and
c. reset means carried by said housing and it's operably associated with said central processor for resetting said central processor to said time zero.

7. The apparatus as defined in claim 6 in which said connector means comprises a thin connector film affixed to the cell phone assembly, said thin connector film having a layer of adhesive disposed thereon for gripping said housing of said timer assembly.

8. The apparatus as defined in claim 6 in which said timing means further comprises audio signal means connected to send central processor for emitting an audio signal upon the passing of an interval of elapsed time.

9. The apparatus as defined in claim 6 in which said cellular phone assembly includes a carrying case and in which said timer assembly is connected to said carrying case.

10. A hand-held communication apparatus comprising:
(a) a cellular phone assembly; and
(b) a timer assembly connected to said cellular phone assembly, said timer assembly comprising:
(i) a housing;
(ii) a manually operated switch carried by said housing;
(iii) connector means connected to said housing for connecting said timer assembly to said cellular phone assembly, said connector means comprising a thin connector film affixed to the cell phone assembly, said thin connector film having a layer of adhesive disposed thereon for gripping said housing of said timer assembly; and
(iv) timing means contained within said housing and operably associated with said manually operated switch for measuring and displaying accumulated time following operation of said manually operated switch, said timing means comprising:
a. a central processor mounted within said housing for measuring the accumulated time in minutes from a time zero following a plurality of operations of said manually operated switch; and
b. a liquid crystal display mounted within said housing for displaying the accumulated time measured by said central processor; and
c. reset means carried by said housing and its operably associated with said central processor for reset-ting said central processor to said time zero; and
d. audio signal means connected to send central processor for emitting an audio signal upon the passing of each minute of elapsed time.

11. The apparatus as defined in claim 10 in which said cellular phone assembly includes a carrying case and in which said timer assembly is connected to said carrying case.
